(19) United States
(12) Patent Application Publication
(10) Pub. No.: US 2007/0020052 A1
(43) Pub. Date: Jan. 25, 2007

(54) Robust vavle seat tool and associated provision method

(75) Inventor: John M. Cirino, Kirtland, OH (US)

Correspondence Address: PEARNE & GORDON LLP, 1801 EAST 9TH STREET, SUITE 1200, CLEVELAND, OH, 44114-3108, US

(73) Assignee: Master Tool Corporation, Grand River, OH (US)

(21) Appl. No.: 11/188,610

(22) Filed: Jul. 25, 2005

(51) Int. Cl. B23C 5/20

(52) U.S. Cl. 407/46

(57) ABSTRACT

A cutting tool assembly includes a body that has a receiving recess and a cartridge located within the receiving recess of the body. The cartridge includes a cutting insert that is exposed from the body for cutting. The assembly also includes a carbon-based material wedge engaged with the body and the cutting insert for retaining the cutting insert in position relative to the body. A method provides the cutting tool assembly and a method provides a prolonged life cutting tool assembly via replacement with a new wedge made of a carbon-based material.

### FIELD OF THE INVENTION

The present invention relates to cutting tools and, in particular, cutting tools that are subject to adverse wear conditions that result from the material that is being cut.

### BACKGROUND OF THE INVENTION

There are a wide range of tools that are used to cut various types of relatively hard materials. For example, there are numerous tools that are use to cut metal. Also, for example, there are many tools used to cut hardened metal.

As can be appreciated, cutting relatively hard material, such as hardened metal, is associated with a great amount of wear on the cutting tool. One well-know approach to deriving increased useful life from a cutting tool is to utilize replaceable cutting portions (e.g., inserts). Such approach addresses the issue of wear by replacing the portions of the tools that tend to wear because of the cutting action. It should be appreciated that replaceable cutting portions must be properly located on a cutting tool, and secured in the proper place during use of the cutting tool.

U.S. Pat. No. 5,704,741, the disclosure of which is incorporated herein, provides one example of a cutting tool that includes replaceable cutting portions that are identified as inserts. In short, summary, the inserts are metal and are held in proper place relative to a cutting tool body by metal wedges that are engaged with the body and the respective insert. In turn, the wedge is held via a metal set screw that is threadingly engaged with the wedge and the body. In general, it is desired to maintain the insert and the wedge and as such, the set screw is tightened to provide a relatively large retaining force to the wedge.

During operation, as a cutting tool moves (e.g., rotates or the like) to cut, the cutting portions remove relatively small portions of the material to be cut. As mentioned, such material may be relatively hard. Also, it should be appreciated that the recently cut portions may engage against other portions of the cutting tool (i.e., portions other than the cutting portions).

### SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with an aspect, the present invention provides a cutting tool assembly that includes a body having a receiving recess. The assembly includes a cartridge located within the receiving recess of the body. The cartridge includes a cutting insert that is exposed from the body for cutting. The assembly also includes a carbon-based material wedge engaged with the body and the cutting insert for retaining the cutting insert in position relative to the body.

In accordance with another aspect, the present invention provides a method of providing a cutting tool assembly. A body that has a receiving recess is provided. A cartridge that includes a cutting insert is provided. The cartridge is located within the receiving recess of the body, with the cutting insert exposed from the body for cutting. A wedge of carbon-based material is provided. The wedge is engaged with the body and the cutting insert for retaining the cutting insert in position relative to the body.

In accordance with another aspect, the present invention provides a method of providing a prolonged life cutting tool assembly that includes a body having a receiving recess, a cartridge located within the receiving recess of the body. The cartridge includes a cutting insert that is exposed from the body for cutting, and a wedge engaged with the body and the cutting insert for retaining the cutting insert in position relative to the body. The method includes removing the wedge, and replacing with a new wedge made of a carbon-based material.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a view of an example tool assembly that incorporates an aspect of the present invention;

FIG. 2 is a view taken along line 2-2 in FIG. 1;

FIG. 3 is an enlarged view of a cartridge from the tool assembly of FIG. 1;

FIG. 4 is a view taken along line 4-4 in FIG. 3;

FIG. 5 is an enlarged, partially-exploded perspective view of a portion of the tool assembly of FIG. 1 and shows a wedge and associated screw, in accordance with one aspect of the present; and

FIG. 6 is a view similar to FIG. 5, but with the wedge secured in place to hold a cutting insert on a cartridge.

### DETAILED DESCRIPTION OF AN EXAMPLE EMBODIMENT

An example embodiment of a device that incorporates the present invention is shown in the drawings. It is to be appreciated that the shown example is not intended to be a limitation on the present invention. Specifically, the present invention can be utilized in other embodiments and even other types of devices. Such other types of devices include various types of cutting devices.

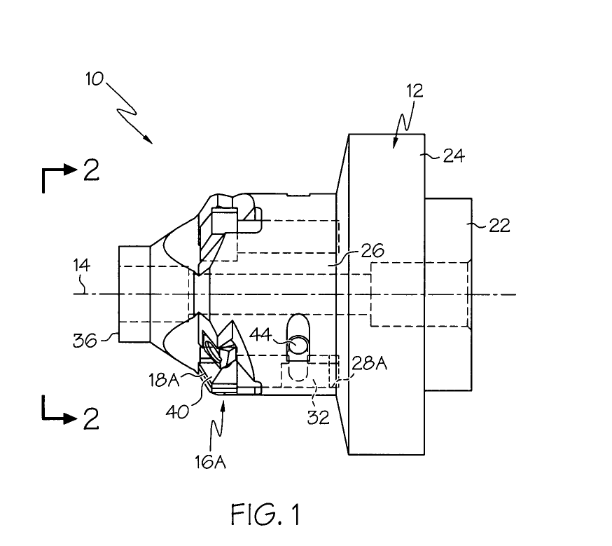

Turning to the shown example of FIG. 1, the device is a rotatable valve seat tool assembly 10 for making (e.g., via cutting) a valve seat (not shown) in an engine head (not shown). A body 12 of the assembly 10 is adapted for mounting on a spindle (not shown) that extends along a longitudinal axis 14 and the assembly is rotatable about the axis via the spindle. Of course, the tool assembly 10 may take other forms, such as a tool for making something other than a valve seat, and could even be moved in a motion other than a rotational motion.

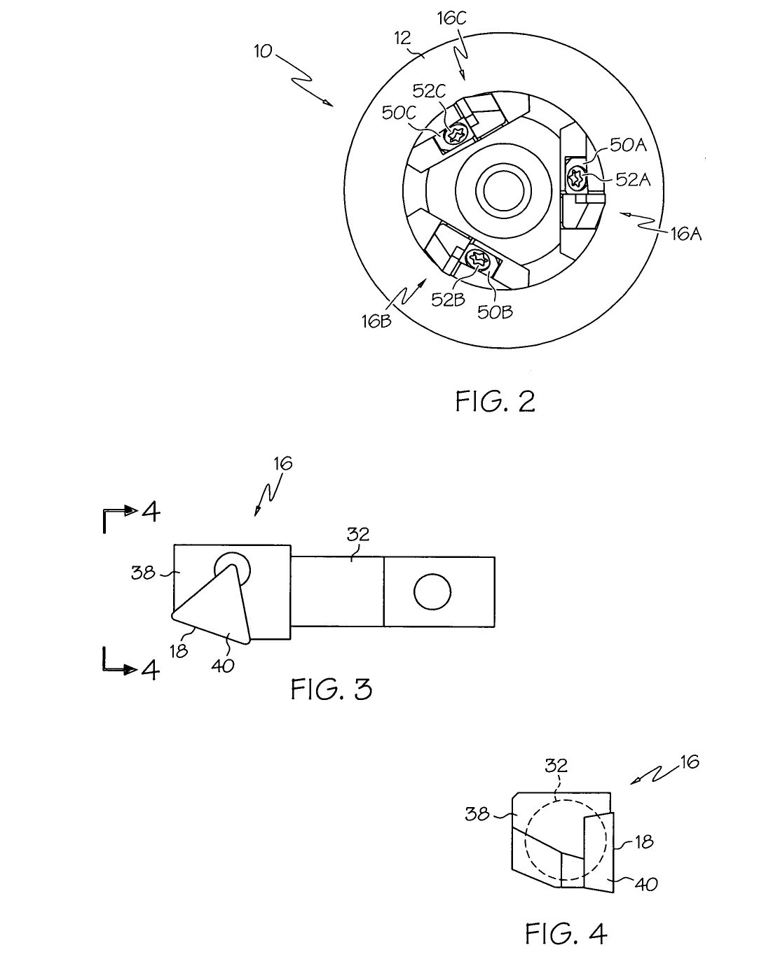

Turning back to the shown example, at least one removable cartridge 16A (FIG. 2) is secured to the body 12 to provide a precision cutting edge 18A within the assembly 10. In the present example, the cutting edge 18A is provided for cutting (i.e., chip removal) to form the valve seat. In general, such a valve seat tool assembly 10 will have one to four cartridges. However, the typical valve seat tool assembly 10 has three cartridges 16A-16C and three respective cutting edges 18A-18C.

With regard to the body 12 (FIG. 1) of the assembly 10, it should be appreciated that the particulars of the body are not limitations on the present invention. In the shown example, the body 12 includes a mounting portion 22 extending axially from one end (i.e., a rear end) of the body. As shown, the mounting portion is cylindrical in configuration, and may be secured to a work spindle in any one of many known or otherwise desired manners. In the shown example, the mounting portion 22 is internally threaded to receive a coupler (not shown).

An enlarged annular shoulder 24 is disposed at an intermediate region of the body 12. A reduced diameter region or land 26 is disposed on the opposite side of the shoulder 24 from the mounting portion 22. At least one recess (e.g., 28A) is provided in the land 26. The number of recesses corresponds to the number of removable cartridges 16A-16C that are provide in the assembly 10. As such, in the shown example, three recesses 28A-28C are provided. Each recess (e.g., 28A) extends into the body 12 generally parallel to the axis 14 and is adapted to receive a cylindrical shank 32 of a respective removable cartridge (e.g., 16A). In the shown example, the cartridges 16A-16C (FIG. 2) are peripherally or circumferentially spaced about the land and are equidistantly spaced about the periphery. The cartridges 16A-16c are described in greater detail below.

A nose portion 36 (FIG. 1) of the body 12 tapers to a minimum diameter at a second or nose end. For the shown example, the nose portion 36 is dimensioned for receipt in an opening (not shown) of the engine head (not shown) in which the valve seat is formed or cut by the tool assembly 10.

In the shown example, all of the cartridges 16A-16c (FIG. 2) are identical. Thus, only one cartridge (FIGS. 3 and 4) is described as a generic representation with the understanding that the description is applicable to the other cartridges. For the generic discussion, the alphabetic suffixes for certain reference numerals are omitted. It is to be appreciated that the cartridges 16A-16C may differ from the shown example.

As mentioned above, the example cartridge 16 includes an elongated cylindrical shank 32 at one end and an insert receiving portion or head 38 at the other end. As shown, the shank 32 is of a slightly smaller diameter than the head 38. A cutting insert 40, which provides the cutting edge 18, is adapted for receipt in a similarly configured region of the head 38. The cutting insert 40 preferably has at least one sharpened cutting edge 18 that is adapted to extend radially outward from both the cartridge 16 and the body 12 at a desired cutting angle. For the example, upon rotation of the assembly 10, the cutting insert 40 engages material (e.g., the engine head) to be cut and removes portions of the material (i.e., chips). It is to be appreciated that the cutting insert 40 is made of a material that is sufficiently durable such that an effective (e.g., sharp) cutting edge can be readily obtained and retained for a relatively long duration. Of course, all of the cartridges 16, with the respective cutting inserts 40, perform the same cutting operation.

In the shown example, the insert 40 may have multiple cutting edges, each of which can be selectively positioned for cutting. For example, the insert 40 is triangular and has three cutting edges. Due to the triangular configuration of the insert 40, one selected cutting edge is positioned to perform the valve seat cutting. Once that cutting edge is worn, the insert is merely rotated (e.g., 120°) to present a new sharpened edge for the cutting operation.

The shank 32 of each cartridge 16 is closely received within the associated recess 28 (FIG. 1) of the body 12. Specifically, the recess 28 and shank 32 are dimensioned so that the shank is completely encapsulated within the recess with only a small amount of clearance. The shank 32 is axially advanced into the recess 28 until the head 38 and cutting insert 40 are properly located relative to the body 12. A securing means 44 that may include a threaded member, such as a set screw, can be utilized to help locate and retain the cartridge 16 relative to the body. It is to be appreciated that such securing means 44 are known in the art and any configuration may be used. As such, the securing means is not a limitation on the present invention.

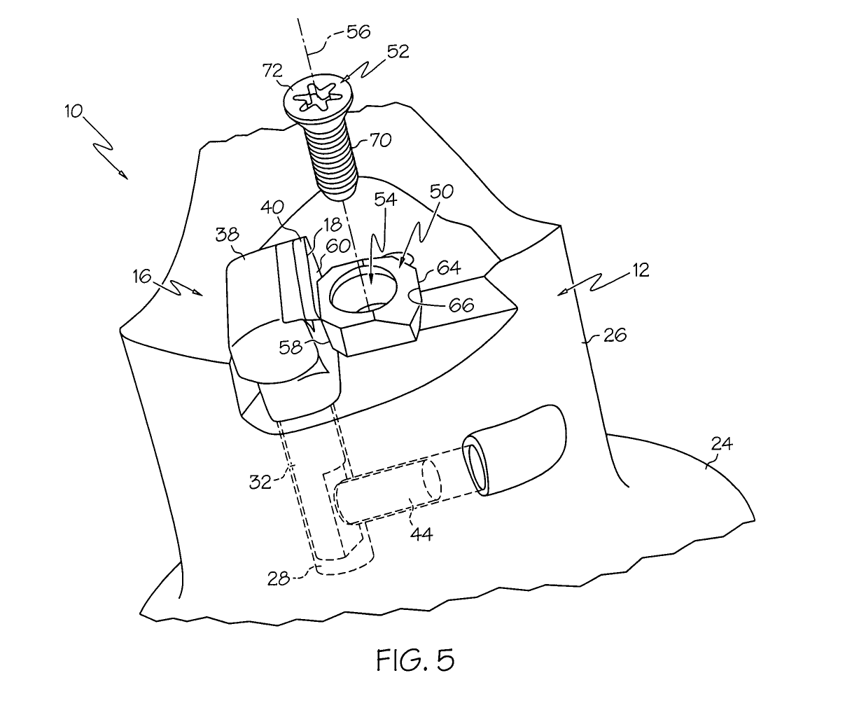

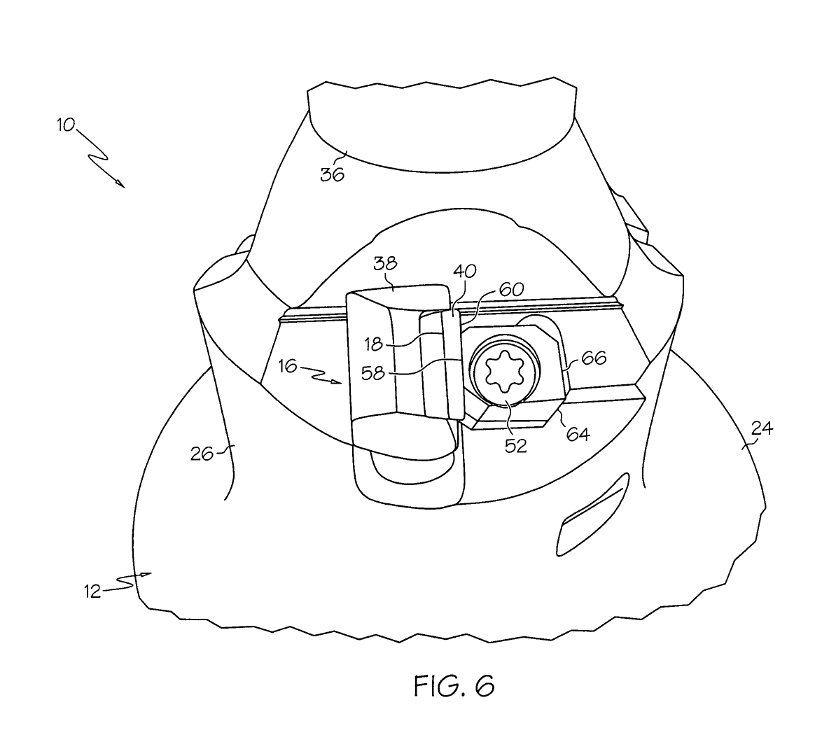

Turning to the cutting insert 40, it should be appreciated that the cartridge 16, itself, does not retain the cutting insert. A wedge 50 (FIGS. 5 and 6), which itself is held in place by a securing means 52, holds both the insert 40 relative to the cartridge 16 and the body 12 via a wedge force. The wedge force can also aid in retaining the respective cartridge 16 in place. It is to be appreciated that three wedges 50A-50C (FIG. 2) are provided for the three cartridges 16A-16C.

Turning to the shown example in FIGS. 5 and 6, the securing means 52 for the wedge 50 is a fastener in the form of a screw. The wedge 50 has a hole 54 and the fastener 52 extends though the hole and into the body along a fastener axis 56.

The wedge 50 has a first surface 58 that abuttingly engages a planar surface 60 of the insert 40. The first surface 58 of the wedge 50 is planar and lies in a plane that is generally parallel to the fastener axis 56. A second surface 64 of the wedge 50 is at an opposed end of the wedge from the location of the first surface 58. The second surface 64 is planar and lies in a plane that is angled or sloped to intersect the fastener axis 56.

The second surface 64 abuttingly engages a planer, sloped surface 66 of the body 12. The sloped surfaces 64 and 66 are complementary (i.e., sloped at the same angle). As the fastener 52 is tightened into the body 12, the wedge 50 member is moved inwardly along the fastener axis 56 by the fastener 52. As the wedge 50 moves along the fastener axis 56, the sloped surfaces 64 and 66 cam against each other. As such, the wedge 50 is moved, laterally, in the direction toward the insert 40 so that the surfaces 58 and 60 tightly abut one another. Thus, a tight press-fitting of the wedge 50 between the body 12 and the cutting insert 40 is accomplished via a single fastener 52.

Turning now to the material to be cut, it should be appreciated that the material may be a metal. For example, the material may be the valve seat material. Moreover, it should be appreciated that the material, such as metal, may be relatively hard. Still further, it should be appreciated that the portion of the material that is removed via the cutting action, commonly referred to as a chip, may have a relatively sharp edge or is otherwise relatively abrasive. In addition, it should be appreciated that as chips are removed, such chips will engage various portions of the assembly 10 other than the cutting inserts 40. It is possible that such chips will cut or abrade the other portions of the assembly 10. Such action may be referred to as chip wash. The ability of the other portions of the assembly 10 to resist the effects of chip wash will dependent upon several factors. However, one factor is strength or durability of the material of the other portions of the assembly 10.

One portion of the assembly 10 that may be subject to a relatively large amount of chip engagement is the wedge 50. This is due in part to the relatively close proximity of the wedge 50 to the cutting insert 40. In accordance with one aspect of the present invention, the wedge 50 is made of tungsten carbide. It should be appreciated that tungsten carbide is a very durable material. However, it should also be appreciated that tungsten carbide cannot be readily be cut to provide threads to threadingly engage a threaded fastener. As such, in accordance with another aspect of the present invention, the tungsten carbide wedge 50 is retained with a fastener 52 that does not threadingly engage the wedge.

Turning to the fastener 52, the shown example is a screw that has a threaded shank 70 that has a maximum diameter that is less that a diameter of the hole 54 though the tungsten carbide wedge 50. Thus, the threaded shank 70 can pass freely through the hole 54. The fastener 52 includes a head 72 that has a diameter that is greater than the diameter of the hole 54 through the tungsten carbide wedge 50. Thus, the head 72 of the fastener 52 bears upon the wedge 50 when the fastener is tightened. The present invention thus differs from the prior approaches, which included the use of a fastener that threadingly engaged a wedge and which did not include the use of tungsten carbide because of the issue concerning threading.

It should be appreciated that the wedge 50 provides a greater amount of holding power as compared to prior art devices. The increased holding power may be attributed to several factors. In part, the fastener 52 can provide a greater amount of force to the wedge because of force transfer to the wedge through the head rather than through the threaded shank. Also, in part, the size difference between the hole 54 through the wedge 50 and the shank 70 can permit a greater amount of lateral shift of the wedge toward the insert 40 as opposed to a fastener that is threadingly engaged to a wedge.

Turning now to an example of material parameters for the tungsten carbide wedge, the material is typically a sintered material. In one example, the material may include some amount of cobalt. For example, the sintered material has a composition percentage of about 1-9% cobalt. In one specific example, the sintered material has a composition percentage of 6% cobalt. As indicated the tungsten carbide is relatively hard material. For example, the tungsten carbide has a hardness of about 89-94 on the Rockwell A harness scale.

It is to be appreciated that the present invention includes a method of providing a cutting tool assembly. It is also to be appreciated that the cutting tool that is provided may be a new tool or the tool may be a refurbished tool. The refurbished tool may be an improvement in that the refurbished tool may have an improved lifespan because of the use of the carbide tungsten wedge instead of a metal wedge. In one example, the present invention thus provides a method of providing a prolonged life cutting tool assembly that includes a body having a receiving recess, a cartridge located within the receiving recess of the body, the cartridge including a cutting insert that is exposed from the body for cutting, and a wedge engaged with the body and the cutting insert for retaining the cutting insert in position relative to the body. The method includes removing the wedge, and replacing with a new wedge made of a carbon-based material.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

1. A cutting tool assembly including:
a body having a receiving recess;
a cartridge located within the receiving recess of the body, the cartridge including a cutting insert that is exposed from the body for cutting; and
a carbon-based material wedge engaged with the body and the cutting insert for retaining the cutting insert in position relative to the body.

2. An assembly as set forth in claim 1, wherein the material of the wedge includes carbide.

3. An assembly as set forth in claim 1, wherein the material of the wedge includes tungsten.

4. An assembly as set forth in claim 1, wherein the cutting insert is metal-based.

5. An assembly as set forth in claim 1, wherein the assembly is rotatable.

6. An assembly as set forth in claim 1, wherein the body has a plurality of recesses and the assembly includes a plurality of cartridges, each received with a respective recess of the body and each including a metal cutting insert exposed from the body for cutting, and the assembly including a plurality of wedges, each engaged with the body and a respective cutting insert for retaining the respective cutting insert in position relative to the body.

7. An assembly as set forth in claim 1, including a retainer that retains the wedge in engagement with the body and the insert.

8. An assembly as set forth in claim 7, wherein the retainer includes a threaded fastener and the body has a threaded portion that threadingly mates with the threaded fastener.

9. An assembly as set forth in claim 8, wherein the wedge has a hole through which the threaded fastener extends.

10. An assembly as set forth in claim 9, wherein the wedge hole is not threaded and the threaded fastener does not threadingly engage the wedge.

11. A method of providing a cutting tool assembly, the method including:
providing a body having a receiving recess;
providing a cartridge that includes a cutting insert;
locating the cartridge within the receiving recess of the body, with the cutting insert exposed from the body for cutting;
providing a wedge of carbon-based material; and
engaging the wedge with the body and the cutting insert for retaining the cutting insert in position relative to the body.

12. A method as set forth in claim 11, wherein the method includes providing the assembly as a rotatable assembly.

13. A method as set forth in claim 11, wherein the body has a plurality of recesses and the assembly includes a plurality of cartridges, each cartridge includes a cutting insert, the method includes locating each cartridge within a respective recess of the body with the respective cutting insert exposed from the body for cutting, the assembly includes a plurality of wedges, and the method includes engaging each wedge with the body and a respective cutting insert for retaining the respective cutting insert in position relative to the body.

14. A method as set forth in claim 11, wherein the method includes providing a retainer that retains the wedge in engagement with the body and the insert.

15. A method as set forth in claim 14, wherein the retainer includes a threaded fastener and the body has a threaded portion, and the method includes mating the threaded fastener with the threaded portion of the body.

16. A method as set forth in claim 15, wherein the wedge has a bore and the method includes extending the threaded fastener through the bore.

17. A method as set forth in claim 11, wherein the material of the wedge includes tungsten.

18. A method of providing a prolonged life cutting tool assembly that includes a body having a receiving recess, a cartridge located within the receiving recess of the body, the cartridge including a cutting insert that is exposed from the body for cutting, and a wedge engaged with the body and the cutting insert for retaining the cutting insert in position relative to the body, the method including:
removing the wedge; and
replacing with a new wedge made of a carbon-based material.

19. A method as set forth in claim 18, wherein the material of the wedge includes tungsten.
